(19) United States
(12) Patent Application Publication
(10) Pub. No.: US 2020/0085242 A1
(43) Pub. Date: Mar. 19, 2020

(54) HOLDING DEVICE FOR S'MORE

(71) Applicants: Lucas G. Kerfeld, Chanhassen, MN (US); Kevin D. Mattson, Chanhassen, MN (US)

(72) Inventors: Lucas G. Kerfeld, Chanhassen, MN (US); Kevin D. Mattson, Chanhassen, MN (US)

(21) Appl. No.: 16/574,052

(22) Filed: Sep. 17, 2019

Related U.S. Application Data
(60) Provisional application No. 62/732,040, filed on Sep. 17, 2018.

(51) Int. Cl. A47J 43/28; A21D 13/11; A23P 20/20

(52) U.S. Cl. CPC A47J 43/283; A23P 20/20; A21D 13/11

(57) ABSTRACT

Embodiments of the invention include s'more holding devices or catchers used in the construction and consumption of a conventional s'more treat.

### CROSS-REFERENCE TO RELATED APPLICATIONS

This U.S. non-provisional patent application claims benefit and priority to U.S. provisional patent application No. 62/732,040 filed on Sep. 17, 2018, titled “HOLDING DEVICE FOR S'MORE”, the contents of which are incorporated herein by reference as if fully set forth herein and for all purposes.

### BACKGROUND OF THE INVENTION

Field of the Invention: The present invention relates generally to oven mitts and pot holders. More particularly, this invention relates to a device adapted to hold and allow for the placement of the individual ingredients within a s'more.

Description of Related Art: The use of oven mitts and pot holders to lift, manipulate and carry cooking receptacles and other items used during cooking is known in the art. When camping or using outdoor heating sources such as wood fires, propane stoves, fire pits and the like, one often does not have access to oven mitts and pot holders for use in lifting, manipulating and carrying hot items used during cooking.

A s'more is a campfire treat popular in the United States and Canada, consisting of a marshmallow and a layer of chocolate placed between two pieces of graham cracker or cookie. S'mores are traditionally cooked using a campfire, though they can also be made at home in an oven, in a microwave or with a s'mores-making kit. A marshmallow, usually held by a metal or wooden skewer, is heated over the fire until it is golden brown. Traditionally, the marshmallow is gooey but not burnt, but, depending on individual preference and cooking time, marshmallows can range from barely warm to charred. The roasted marshmallow is then added on top of half of a graham cracker and a piece of chocolate. The second half of the cracker is then added on top. At this point, a fully assembled and ready-to-eat s'more has been prepared.

This current assembly method is often problematic with hot marshmallows potentially burning a user, exposing the user to a heated metal skewer, and often leaves a messy and sticky residue on the hands of the user. The removal of the freshly roasted marshmallow from the skewer may be tricky because both may be simply too hot to touch. Additionally, it is frequently cumbersome to assemble the freshly roasted marshmallow with its component parts while holding a skewer. Accordingly, there exists a need in the art for a device that simplifies the process of making a s'more and that may address the aforementioned problems.

### SUMMARY OF THE INVENTION

A S'more as it is known within the art is generally a snack commonly consumed around a campfire and traditionally utilizes a pair of graham crackers, a chocolate square, and a heated marshmallow. Traditionally, this marshmallow is placed onto a skewer and heated, after reaching the desired temperature, the marshmallow is placed adjacent to the chocolate square and sandwiched in between the graham crackers.

It would be advantageous to have an apparatus that prevents roasted marshmallows from getting on a user's hands. Furthermore, it would also be advantageous to have an apparatus that held the ingredients for S'mores together during assembly and even during eating. Still further, it would be advantageous to have an apparatus that the whole family could use. Therefore, there currently exists a need in the market for an apparatus that is specifically adapted to remove a marshmallow from a skewer and hold S'more ingredients in place during assembly and eating.

An embodiment of a s'more holding device is disclosed. The embodiment of a s'more holding device may include a rectangular bottom having a bottom surface and a upper surface, two opposed long edges, two opposed short edges and a centrally oriented pivot axis passing lengthwise through the bottom and parallel to the two opposed long edges. The embodiment of a s'more holding device may further include two clamping members connected to each of the two opposed long edges of the bottom, each of the two clamping members extending in a direction upward from the upper surface and forming a finger pocket for insertion of a user's thumb or fingers, each pocket forming a thermal membrane, the membrane having an inner digital surface for receiving the user's thumb or fingers and an external grasping surface. According to the embodiment of a s'more holding device, each of the two clamping members may further include a cracker support wall, the cracker support wall extending perpendicularly from and connecting both fins, the cracker support wall extending upward from the upper surface of the rectangular bottom and extending near to, but spaced apart from, the external grasping surface, thereby forming a cracker slot disposed in between the external grasping surface and the cracker support wall, the cracker slot configured to receive and hold a cracker.

An embodiment of a method of forming a s'more is disclosed. The method may include providing a s'more catcher having two finger pockets configured to receive fingers or thumb and having two cracker slots, a skewer, two crackers, an uncooked marshmallow, a chocolate bar and a source of heat. The embodiment of a method of forming a s'more may further include inserting the two crackers into the two cracker slots in the s'more catcher, thereby leaving an interior space between the two slotted crackers. The embodiment of a method of forming a s'more may further include resting the chocolate bar on one of the two crackers. The embodiment of a method of forming a s'more may further include inserting fingers and thumb of a user into the two finger pockets with the s'more catcher in the open position. The embodiment of a method of forming a s'more may further include skewering the uncooked marshmallow on a distal end of the skewer. The embodiment of a method of forming a s'more may further include grasping a proximate end of the skewer. The embodiment of a method of forming a s'more may further include maneuvering the uncooked marshmallow on the skewer toward and proximate to the source of heat. The embodiment of a method of forming a s'more may further include roasting the marshmallow on the distal end of the skewer until cooked. The embodiment of a method of forming a s'more may further include removing the skewered roasted marshmallow from the source of heat. The embodiment of a method of forming a s'more may further include inserting the skewered roasted marshmallow into the interior space. The embodiment of a method of forming a s'more may further include clamping the user's fingers and thumb towards each other to grasp the skewered cooked marshmallow. The embodiment of a method of forming a s'more may further include pulling the skewer from the roasted marshmallow to form a ready-to-eat s'more.

An embodiment of a s'more catcher for assembling and consuming a s'more treat is disclosed. The embodiment of a s'more catcher may include a rectangular bottom having a bottom surface and a upper surface, two opposed long edges, two opposed short edges and a centrally oriented pivot axis passing lengthwise through the bottom and parallel to the two opposed long edges. The embodiment of a s'more catcher may further include two mirror-image clamping members connected to each of the two opposed long edges of the rectangular bottom. According to one embodiment, each clamping member may further include a hollow finger pocket including an inner digital surface, an external grasping surface and an external protective surface, the external grasping and protective surfaces meeting at a rim of the clamping member, the finger pocket configured to receive a user's fingers or thumb, the finger pocket further comprising a thermally insulating membrane disposed between the inner digital surface and the external grasping and protective surfaces. According to this one embodiment, each clamping member may further include two fins extending perpendicularly from opposite ends of the external grasping surface, each fin extending perpendicularly from a corner of the rectangular bottom and along one of the two opposed short edges of the rectangular bottom. According to this one embodiment, each clamping member may further include a cracker support wall extending perpendicularly between the two fins and along the rectangular bottom parallel to the pivot axis.

The invention now will be described more fully hereinafter with reference to the accompanying drawings, which are intended to be read in conjunction with both this summary, the detailed description and any preferred and/or particular embodiments specifically discussed or otherwise disclosed. It will be understood that this invention may be embodied in many different forms and should not be construed as limited to the embodiments set forth herein. Rather, these particular embodiments are provided by way of illustration only and so that this disclosure will be thorough, complete and will fully convey the full scope of the invention to those of ordinary skill in the art.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is a top perspective image of the first embodiment of a s'more catcher, according to the present invention.

FIG. 2 is a bottom perspective image of the first embodiment of a s'more catcher, according to the present invention.

FIG. 3 is a composite image of the first embodiment of a s'more catcher loaded with crackers and chocolate bar and ready to receive a roasted marshmallow in the open position, according to the present invention.

FIG. 4 is an image of a s'more held within the first embodiment of a s'more catcher in the closed position, according to the present invention.

FIGS. 5-9 are front, top, bottom, right side and perspective wireframe diagrams, respectively of the first embodiment of the s'more catcher, according to the present invention.

FIGS. 10A and 10B are a flowchart of an embodiment of a method of using a s'more catcher, according to the present invention.

FIGS. 11A and 11B are perspective views of a bear embodiment of a s'more catcher, according to the present invention.

FIGS. 12-16 are perspective, top, bottom, rear and side wireframe views, respectively, of a bear embodiment of a s'more holding device, according to the present invention.

FIGS. 17A and 17B are perspective views of shark embodiments of a s'more holding device, respectively, according to the present invention.

FIGS. 18-22 are perspective, top, bottom, rear and side wireframe views, respectively, of the shark embodiment of a s'more holding device shown in FIG. 17A, according to the present invention.

FIG. 23 is a perspective image of a second embodiment of a s'more catcher in the open position, according to the present invention

### DETAILED DESCRIPTION

Embodiments of the present invention are generally devices adapted to aid in the assembly and consumption of a s'more treat. Embodiments of the present invention are adapted to allow a user to generally hold a s'more and protect themselves from heat during assembly of the s'more while maintaining a mess free environment. The present invention advantageously fills the aforementioned deficiencies of the prior art by providing a s'more catching device, which provides a grasping means to allow a user to remove a skewer, stick, or rod used for roasting marshmallows from the roasted marshmallow.

Embodiments of the present invention are provided with many useful features. The following are a nonexhaustive list of useful features of embodiments of the present invention. Embodiments of the inventive s'more catcher are reusable. Embodiments of the present invention may include integrated slots to hold crackers used to make a s'more. Embodiments of the present invention may include hollow projections for the placement and thermal protection of fingers. Embodiments of the present invention fulfill the need for a device adapted to hold a hot s'more. Embodiments of the present invention provide a s'more holding device that does not suffer from the problems or deficiencies associated with prior art solutions. Another advantage of embodiments of the present invention is its ability to hold the crackers and chocolate in place prior to and after insertion of a freshly roasted marshmallow. Embodiments of the present invention also may include support ribs for strength and durability.

Following are more detailed descriptions of various related concepts related to, and particular embodiments of, methods and apparatus according to the present invention. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes. It will be understood that the terms “s'more catcher” and “s'more holding device” are used synonymously herein.

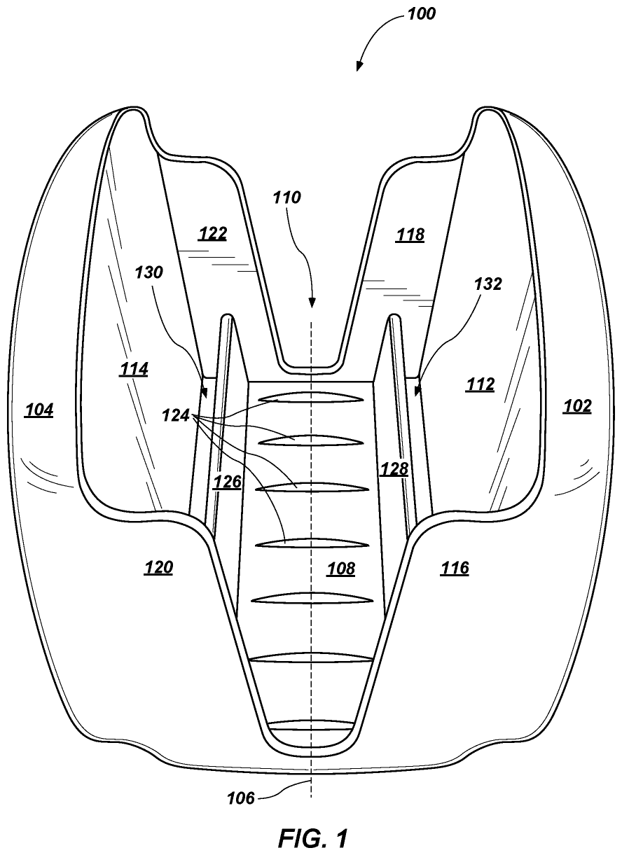

FIG. 1 is a top perspective image of the first embodiment of a s'more catcher 100 according to the present invention. As shown in FIG. 1, s'more catcher 100 has a generally clam-shell appearance with two mirror-image opposed right and left clamping members 102 and 104, respectively. The right and left clamping members 102 and 104 are connected together at the bottom 108 of the s'more catcher 100, the bottom being generally rectangular in shape. The lengthwise axis of the bottom forms a pivot axis 106, about which the two opposed right and left clamping members 102 and 104 are allowed to pivot towards and away from one another. FIG. 1 illustrates the first embodiment of a s'more catcher 100 in the open position.

The grasping surfaces 112 and 114, of the right and left clamping members 102 and 104, respectively, define an interior space 110 that is configured to receive the components of a s'more (not shown in FIG. 1). It will be understood that because of the symmetry of s'more catcher 100, the use of the terms right and left as used herein is arbitrary. The interior space 110 of catcher 100 is defined generally by the bottom 108 and grasping surfaces 112 and 114 of the right and left clamping members 102 and 104, respectively. The interior space 110 of catcher 100 is further defined by the fins 116 and 118 extending from the right clamping member 102, and fins 120 and 122 extending from the left clamping member 104.

FIG. 1 further illustrates additional structural features formed in the bottom 108 of the s'more catcher 100. More particularly, a plurality (seven shown) of stiffening ribs 124 are formed along the bottom 108 of catcher 100. The stiffening ribs 124 add to the structural rigidity of the catcher 100 and in conjunction with the structure of the bottom 108 operate as an open-biased spring about which the two opposed right and left clamping members 102 and 104 are allowed to pivot towards and away from one another, as noted above.

FIG. 1 additionally illustrates two cracker support walls 126 and 128 surrounding the stiffening ribs 124. More particularly, cracker support wall 126 extends generally perpendicularly up from the bottom 108 and connects between (and generally perpendicularly to) fins 120 and 122, thereby forming a cracker slot 130 for receiving a graham or similar cracker (not shown in FIG. 1). Similarly, cracker support wall 128 extends generally perpendicularly up from the bottom 108 and connects between and generally perpendicularly to fins 116 and 118, thereby forming a cracker slot 132 for receiving a graham or similar-sized cracker (again not shown in FIG. 1).

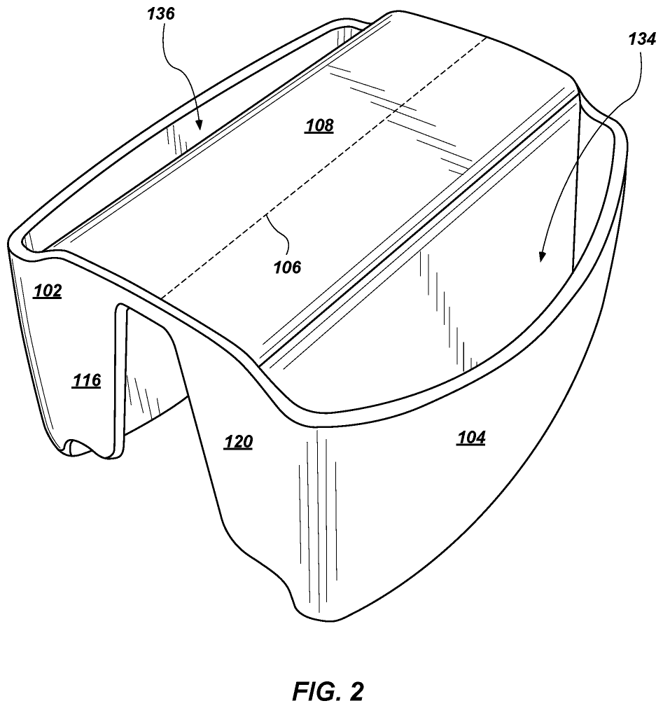

FIG. 2 is a bottom perspective image of the first embodiment of a s'more catcher 100 shown in the open position, according to the present invention. FIG. 2 illustrates two finger pockets, 134 and 136 that are formed within the left and right clamping member 104 and 102, respectively. The finger pockets 134 and 136 are configured to receive and encase fingers or thumb of a user (not shown) during use of the s'more catcher 100. FIG. 2 further illustrates the bottom side of the generally rectangular-shaped bottom 108 and pivot axis 106 passing therethrough. The bottom 108 provides structural support for the catcher 100, acts as a flexible spine that allows bending to occur along the lengthwise pivot axis 106, and forms the basis for a open-biased spring.

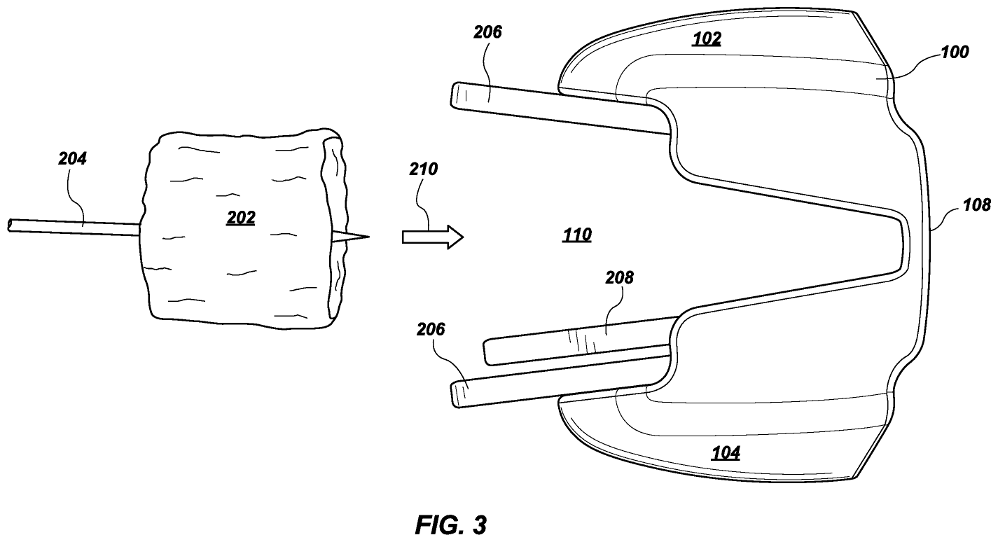

FIG. 3 is a composite image of the first embodiment of a s'more catcher 100 loaded with crackers 206 and chocolate bar 208 and ready to receive a roasted marshmallow 202, according to the present invention. FIG. 3 illustrates a rotated front view of the first embodiment of a s'more catcher 100 with right and left clamping members 102 and 104 as well as bottom 108 (shown on the right). As shown in FIG. 3, a freshly roasted marshmallow 202 on the end of a skewer 204 is in position to be inserted (see arrow 210) into the interior space 110 between the upper cracker 206 and lower cracker 206 with adjacent chocolate bar 208. Though not visible in FIG. 3, the crackers 206 are held in the cracker slots (but see, FIGS. 1, 130 and 132) by cracker support walls (FIGS. 1, 126 and 128). The chocolate bar simply rest on top of the lower cracker 206.

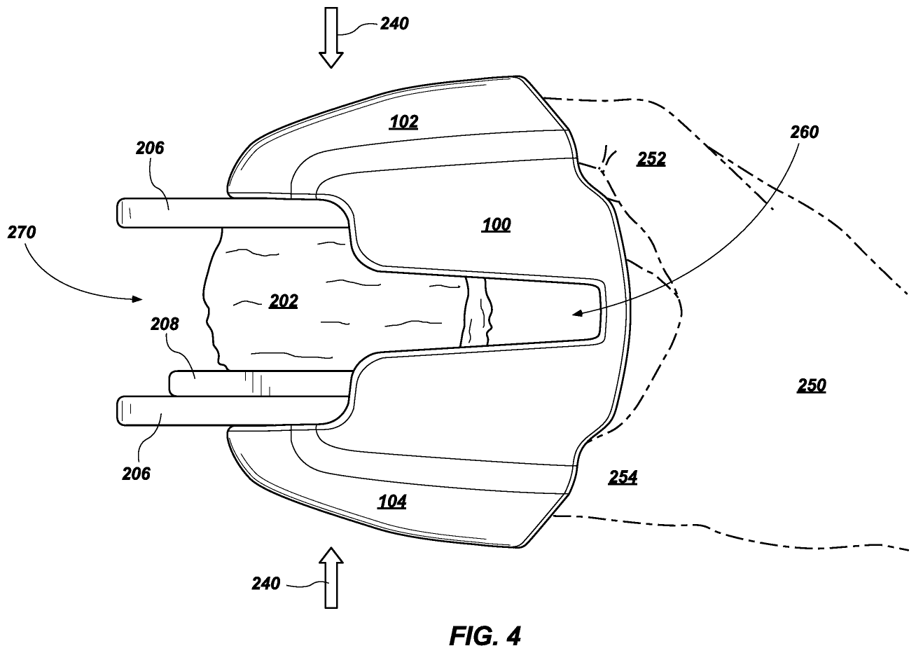

FIG. 4 is an image of an assembled and ready to eat s'more, shown generally at arrow 270, held within the first embodiment of a s'more catcher 100 shown in the closed position, according to the present invention. FIG. 4 illustrates a freshly roasted marshmallow that has been removed from the skewer (not shown, but see 203, FIG. 3) used to roast it over an open flame or other heat source (also not shown).

As shown in FIG. 4, the user has inserted fingers 252 and thumb 254 into the finger pockets (not visible in FIG. 4, but see FIGS. 2, 134 and 136) and has grasped the roasted marshmallow 202 by clamping the left and right clamping members 104 and 102 towards each other (see arrows 240) bringing the upper cracker 206 and chocolate bar into contact with (and compressing) the freshly roasted marshmallow 202. In this closed position, the user may pull out the skewer (not shown, but see 203, FIG. 3) and leave the ready-to-eat s'more 270 in the first embodiment of a catcher 100.

The gap 260 formed between the right and left clamping members 102 and 104 allows the user flexibility in grasping the roasted marshmallow 202 from a skewer (not shown, but see 203, FIG. 3). That is to say that a user has more than 180° of freedom in selecting the angle from which the skewer (not shown, but see 203, FIG. 3) is aligned relative to the pivot axis (not shown in FIG. 4) when inserting and grasping the roasted marshmallow 202 and pulling out the skewer (not shown, but see 203, FIG. 3).

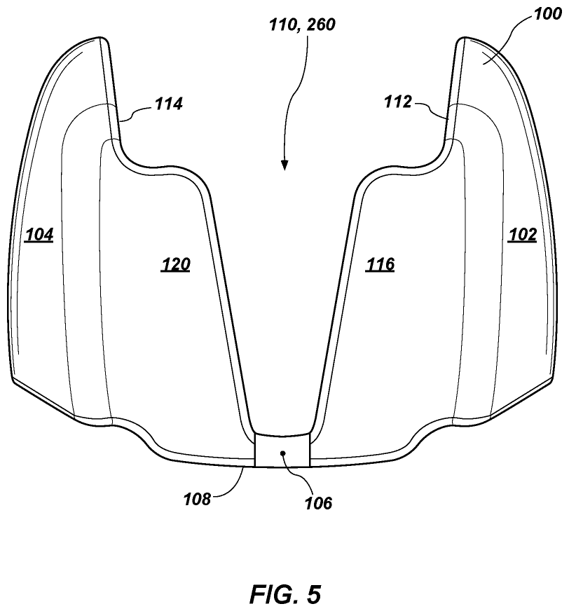

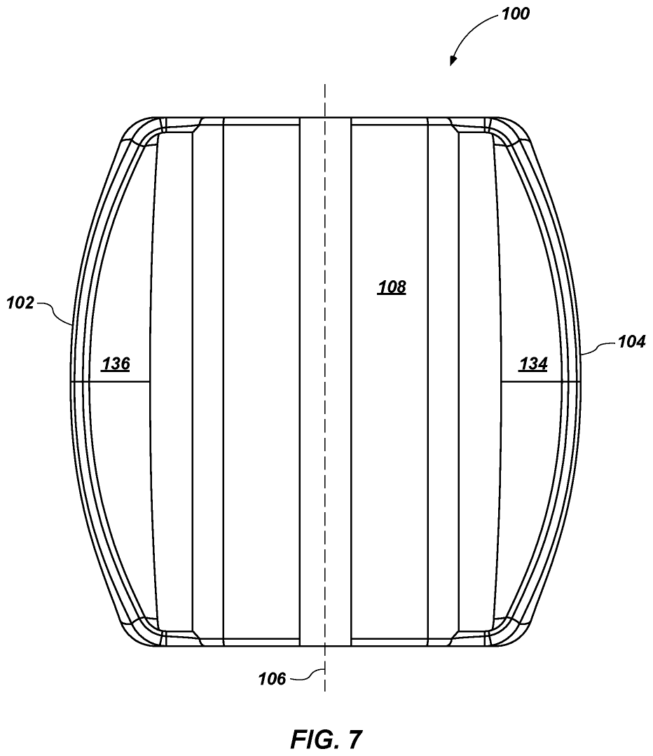

FIGS. 5-9 are front, top, bottom, right side and perspective wireframe diagrams, respectively of the first embodiment of the s'more catcher, according to the present invention. As illustrated in FIGS. 5-9, s'more catcher 100 has a generally clam-shell appearance with two mirror-image, opposed right and left clamping members 102 and 104, respectively. The right and left clamping members 102 and 104 are connected together at the bottom 108 of the s'more catcher 100, where a pivot axis 106 (dot in FIG. 5 and dashed line in FIG. 7. The inner surfaces 112 and 114 of the right and left clamping members 102 and 104 define an interior space 110 that is configured to receive the components of a s'more (not shown). It will be understood that because of the symmetry of s'more catcher 100, the use of the terms right and left as used herein is arbitrary.

More particularly the front view of the s'more catcher 100 shown in FIG. 5 illustrates the right and left clamping members 102 and 104, fin 116 extending from grasping surface 112 and fin 120 extending from grasping surface 114. As shown in FIG. 5, the pivot axis 106 passes into and out of the surface of FIG. 5 and the point within the bottom 108 shown in FIG. 5. The inner space 110 between the left and right clamping members 102 and 104 also forms a gap 260 that provides more than 180° of freedom for grasping a roasted marshmallow (not shown, but see 202 in FIGS. 3 and 4) that is impaled on a skewer (also not shown, but see 204 in FIG. 3).

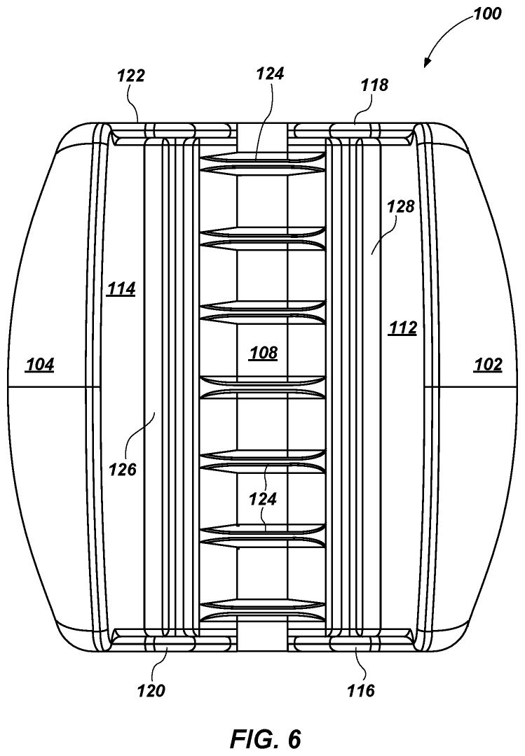

FIG. 6 illustrates a plurality of stiffening ribs 124 formed in the top surface of the bottom 108 of the s'more catcher 100. While FIG. 6 illustrates seven (7) stiffening ribs 124, it will be understood that any suitable number of stiffening ribs may be employed in various embodiments of a s'more catcher according to the teachings of the present invention. The symmetry between the two mirror-image, opposed right and left clamping members 102 and 104 is well illustrated in FIG. 6. The grasping surface 114 opposite cracker support wall 126 are shown on the left side of FIG. 6. Similarly the grasping surface 112 opposite cracker support wall 128 are shown on the right side of FIG. 6. FIG. 6 also illustrates cracker support wall 126 sandwiched between fins 120 and 122. Similarly, cracker support wall 128 is sandwiched between fins 120 and 122.

The bottom view of FIG. 7 best illustrates the finger pockets 134 and 136 that are formed into the right and left clamping members 102 and 104 of the first embodiment of a s'more catcher 100, respectively. The finger pockets 134 and 136 protect the user's fingers 252 and thumb 254 during use of the s'more catcher 100, from the heat of the roasted marshmallow (not shown, but see 202 in FIGS. 3 and 4) and skewer (not shown, but see 204 in FIG. 3) as well as the sticky assembled s'more (not shown, but see 270 in FIG. 4), during consumption thereof.

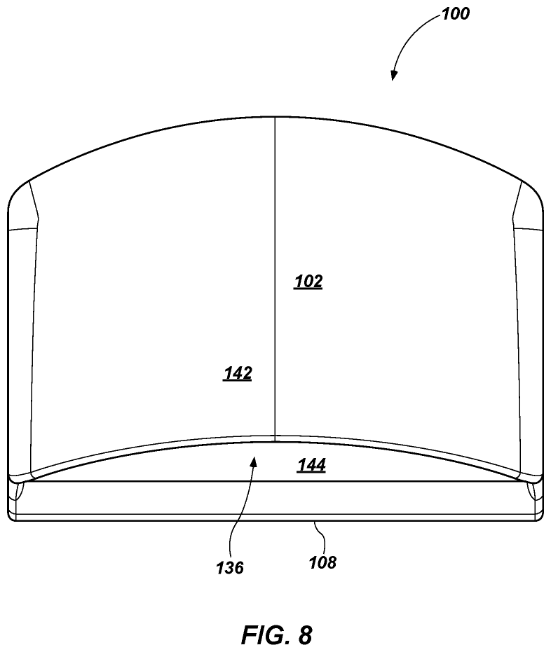

FIG. 8 shows a right side view of the first embodiment of a s'more catcher 100. It will be understood that the left side view (not illustrated) is a mirror-image, and thus identical to FIG. 8. Right clamping member 102 has an external surface 142, a grasping surface 112 (not shown in FIG. 8, but see FIG. 1) and an internal surface 144 that the user's fingers (not shown, but see 252 in FIG. 4) and thumb (not shown, but see 254 in FIG. 4) press against to grasp the roasted marshmallow (not shown, but see 202 in FIG. 4). The finger pockets 134 and 136 are accessible from the bottom 108 of the first embodiment of a s'more catcher 100.

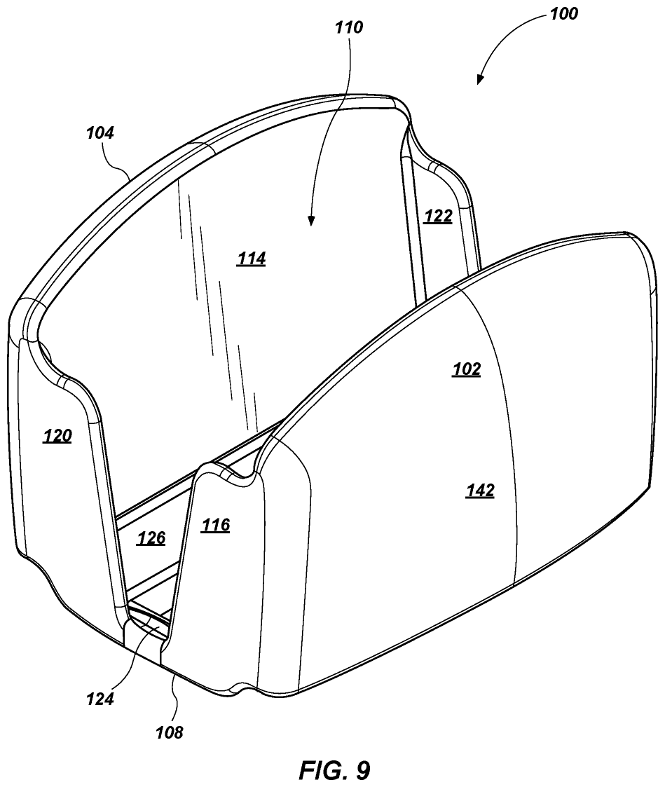

FIG. 9 is another perspective wireframe diagram of the first embodiment of a s'more catcher 100, according to the present invention. FIG. 9 illustrates right and left clamping members 102 and 104, separated by interior space 110. Left clamping member 104 may include fins 120 and 122 sandwiching cracker support wall 126. Left clamping member 104 may further include grasping surface 114. FIG. 9 illustrates one of a plurality of stiffening ribs 124 formed in the bottom 108. Right clamping member 102 may include an external surface 142 and fins (only one fin 116 shown and one hidden) opposite each other.

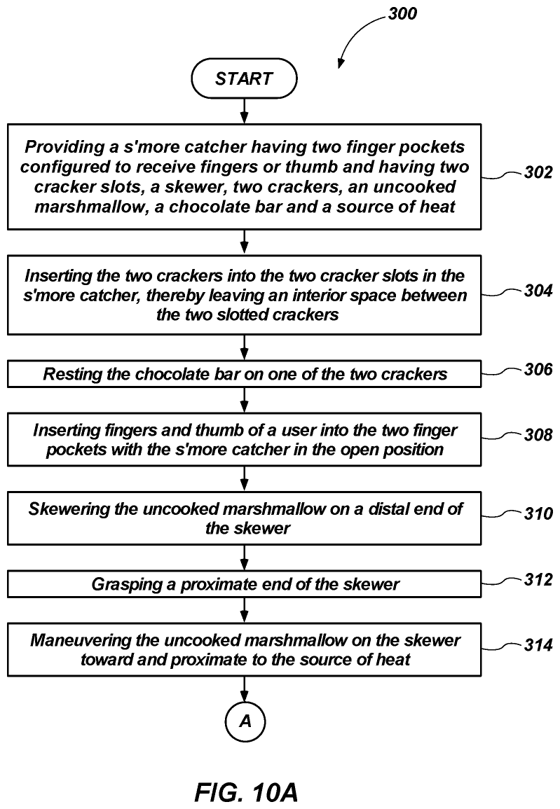

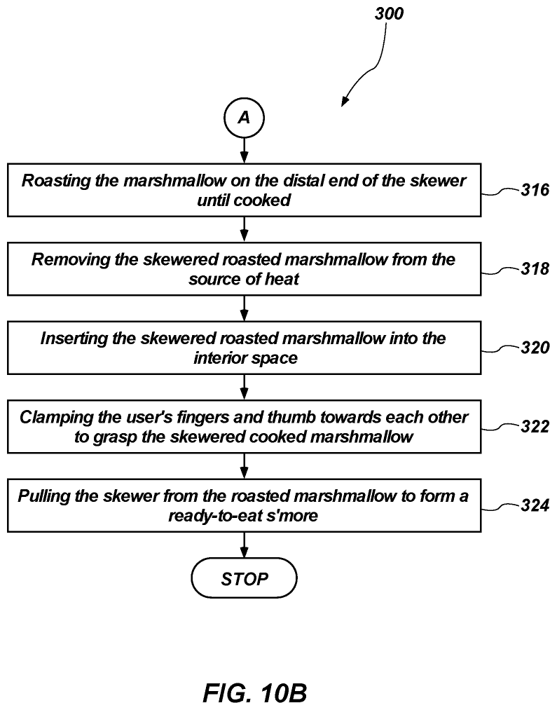

Having discussed a first embodiment of a s'more catcher 100 in substantial detail, a method 300 of using a s'more catcher will now be described with reference to FIGS. 10A and 10B. FIGS. 10A and 10B form a flowchart of an embodiment of a method 300 of using a s'more catcher, according to the present invention. Method 300 may include providing 302 a s'more catcher having two finger pockets. The two finger pockets may be configured to receive fingers or thumb or a user. The s'more catcher may further include two cracker slots, a skewer, two crackers, an uncooked marshmallow, a chocolate bar and a source of heat. Method 300 may further include inserting 304 the two crackers into the two cracker slots in the s'more catcher, thereby leaving an interior space between the two slotted crackers. Method 300 may further include resting 306 the chocolate bar on one of the two crackers. In this position, the chocolate bar may simply be held by gravity and friction against a lower and horizontally oriented cracker, see for example, chocolate bar 208 of FIG. 3. Method 300 may further include inserting 308 fingers and thumb of a user into the two finger pockets with the s'more catcher in the open position. For example, FIG. 3 illustrates the s'more catcher 100 in the open position.

Method 300 may further include skewering 310 the uncooked marshmallow on a distal end of the skewer. Method 300 may further include grasping 312 a proximate end of the skewer. Method 300 may further include maneuvering 314 the uncooked marshmallow on the skewer toward and proximate to the source of heat. Method 300 may further include roasting 316 the marshmallow on the distal end of the skewer until cooked. Method 300 may further include removing 318 the skewered roasted marshmallow from the source of heat. Method 300 may further include inserting 320 the skewered roasted marshmallow into the interior space. Method 300 may further include clamping 322 the user's fingers and thumb towards each other to grasp the skewered cooked marshmallow. Method 300 may further include pulling 324 the skewer from the roasted marshmallow to form a ready-to-eat s'more.

Having described a first embodiment of a s'more catcher 100 and a method of forming a s'more 300, various alternative embodiments of the s'more holding device are described below with reference to additional drawings. By employing the novel structural features of the s'more catcher 100, various animal themes, for example and not by way of limitation, a bear or shark, may be applied to the visible structural features of further embodiments of a s'more holding device, according to the present invention.

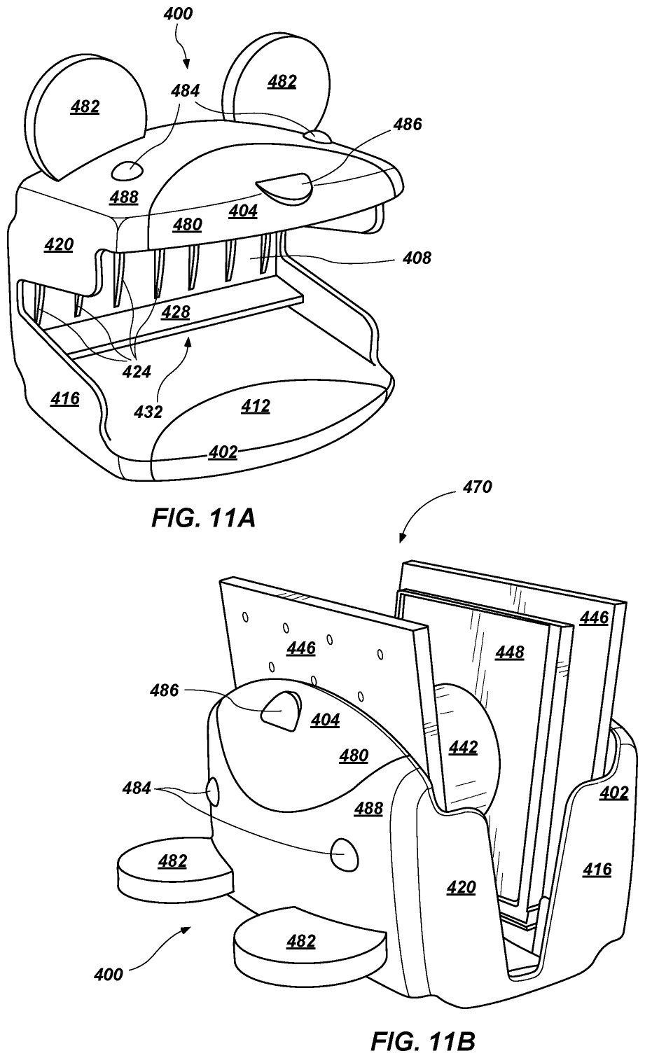

FIGS. 11A and 11B are perspective views of a bear embodiment of a s'more holding device 400 according to the present invention. More particularly, FIG. 11A is a perspective view of a bear embodiment of a s'more holding device 400 in the open position, according to the present invention. FIG. 11B is another perspective view of the bear embodiment of a s'more holding device shown in FIG. 11A, with a s'more 470 and its constituent components in the open position.

As can be seen in FIG. 11A, holding device 400 has essentially the same structural features of catcher 100, including right and left clamping members 402 and 404, a bottom 408, with stiffening ribs 424, grasping surface 412, cracker slot 432 and fins 416 and 420. Distinctive features of the holding device 400 may include external coloring, namely white semi-circular nose patches 480 and otherwise generally brown coloring 488. Other distinctive features of the holding device 400 may include facial features of a bear, namely, ears 482, eyes 484 and a nose 486 selectively placed on holding device 400 to give the appearance of a cartoon bear with its mouth open. The two eyes 484 and one nose 486 are black in color. FIG. 11B illustrates placement of crackers 446 (two shown), chocolate bar 448 and marshmallow 442 within the embodiment of a s'more holding device 400 in the open position.

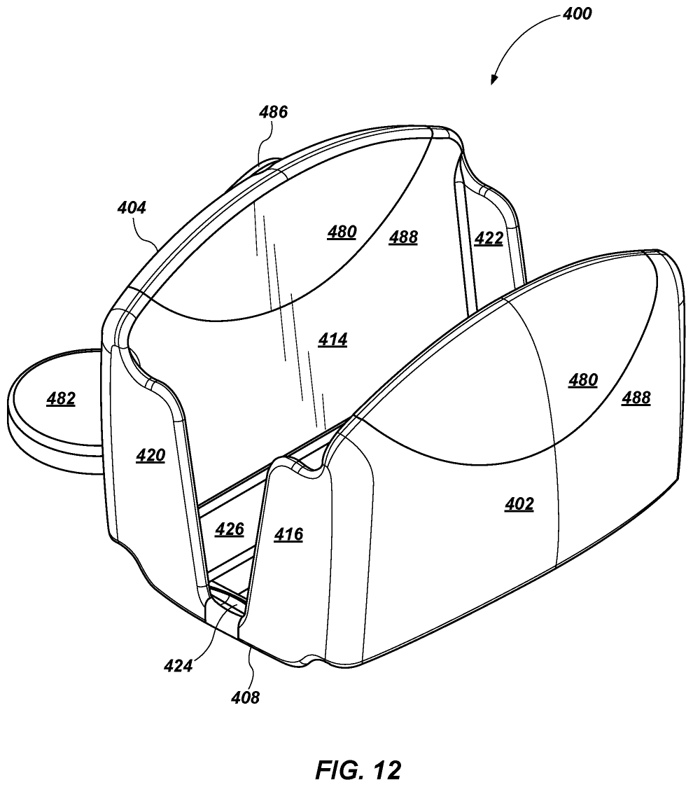

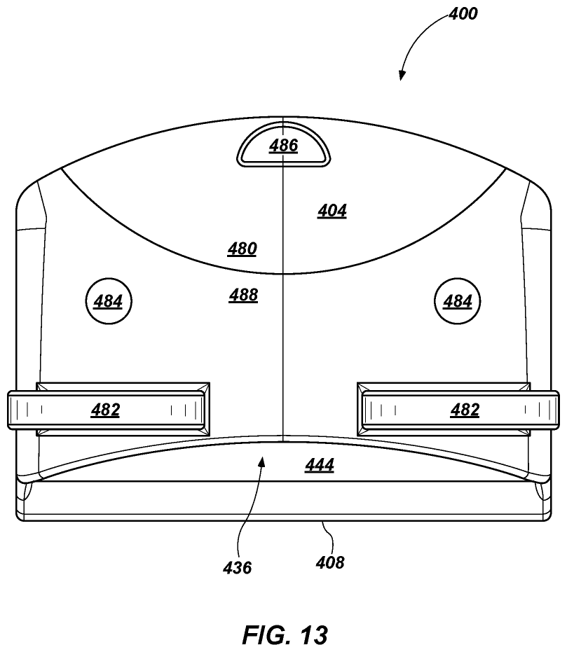

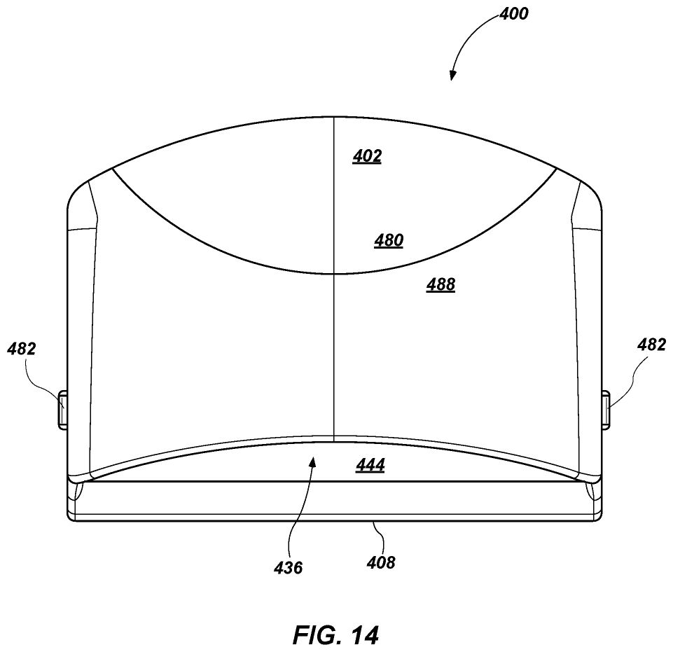

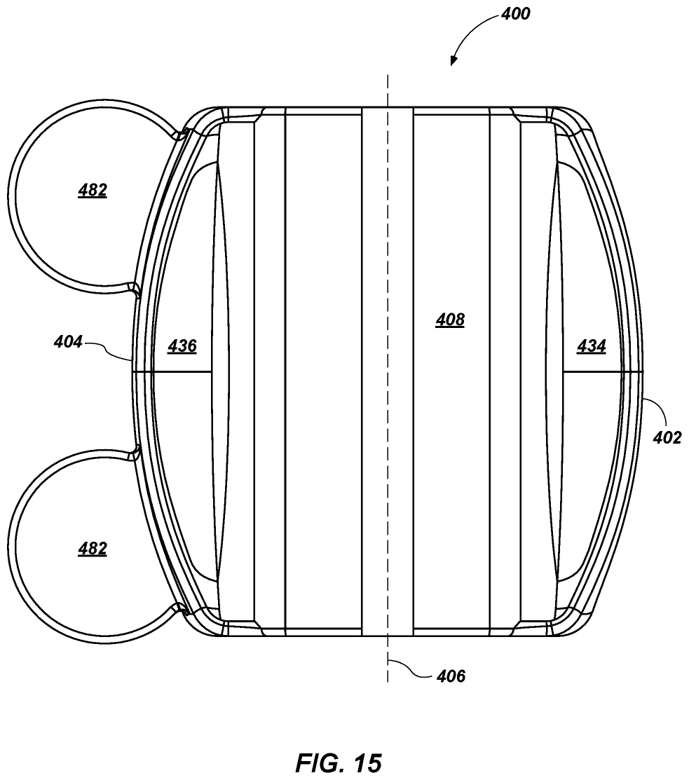

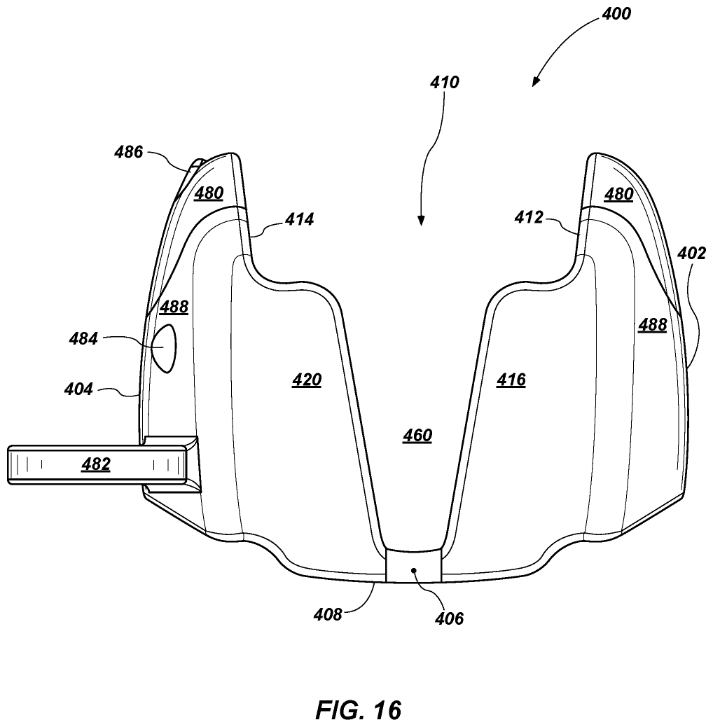

FIGS. 12-16 are perspective, top, bottom, rear and side wireframe views, respectively, of a bear embodiment of a s'more holding device 400, according to the present invention. As shown in FIGS. 12-16, the embodiment of a device 400 may include right and left clamping members 402 and 404 and a pivot axis 406 passing through the bottom 408. The bottom may have a plurality of stiffening ribs 424, see, e.g., FIGS. 11A and 12. The embodiment of a device 400 may further include an interior space 410 and gap 460 disposed between right and left clamping members 402 and 404. The embodiment of a device 400 may further include fins 416, 420 and 422 extending from right and left clamping members 402 and 404 and surrounding cracker support walls 426 and 428. Cracker slots (not shown) are formed between cracker support walls 426 and 428 and grasping surfaces 412 and 414. The bottom view shown in FIG. 15 best illustrates the finger pockets 434 and 436. FIG. 13 illustrates finger pocket 436 and internal surface 444 which is configured to receive the fingers or thumb (neither shown) of a user (also not shown). Aesthetically, the bear embodiment of a s'more holding device 400 has white semi-circular nose patches 480 and generally brown coloring elsewhere on the outer surface, except for the two black bear eyes 484 and black bear nose 486. The two decorative bear ears 482 are brown in coloring. It will be understood that while the particular color selection, i.e., white, brown and black coloring, have been used in this particular bear embodiment of a s'more holding device 400, other colors could be employed consistent with the teachings of the present invention.

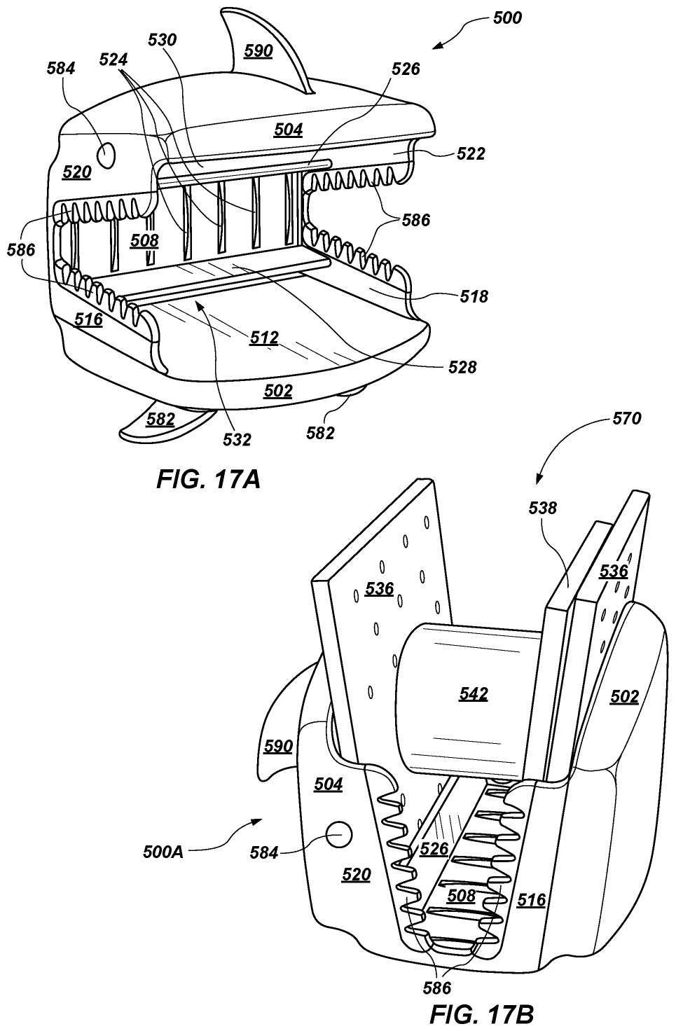

FIGS. 17A and 17B are perspective views of shark embodiments of a s'more holding device 500 and 500A, respectively, according to the present invention. More particularly, FIG. 17A is a perspective view of a bear embodiment of a s'more holding device 500 in the open position, according to the present invention. FIG. 17B is a perspective view of the bear embodiment of a s'more holding device 500A, with a s'more 570 and its constituent components loaded and in the open position.

As can be seen in FIG. 17A, holding device 500 has essentially the same structural features of catcher 100, including right and left clamping members 502 and 504, a bottom 508, with stiffening ribs 524, grasping surface 512, cracker slot 532 and fins 516 and 520. Distinctive features of the holding devices 500 and 500A may include facial features of a shark, namely, 4 rows of teeth 586, two pectoral fins 582, two shark eyes 584 and a dorsal fin 590 selectively placed on holding device 500 to give the appearance of a cartoon shark with its mouth open. Other distinctive features of the holding devices 500 and 500A may include external coloring, namely, white for the right clamping member 502 and 4 rows of teeth 586 and generally blue for everything else, except the black shark eyes 584.

FIG. 17B illustrates placement of crackers 536, chocolate bar 538 and marshmallow 542 within the embodiment of a s'more holding device 500A in the open position. S'more holding device 500A differs from s'more holding device 500 in that it does not include the two pectoral fins 582 disposed on the surface of right clamping member 502. It will be understood that various aesthetic surface features and colors may be employed with other unillustrated embodiments of a shark s'more holder device, consistent with the teachings of the present invention.

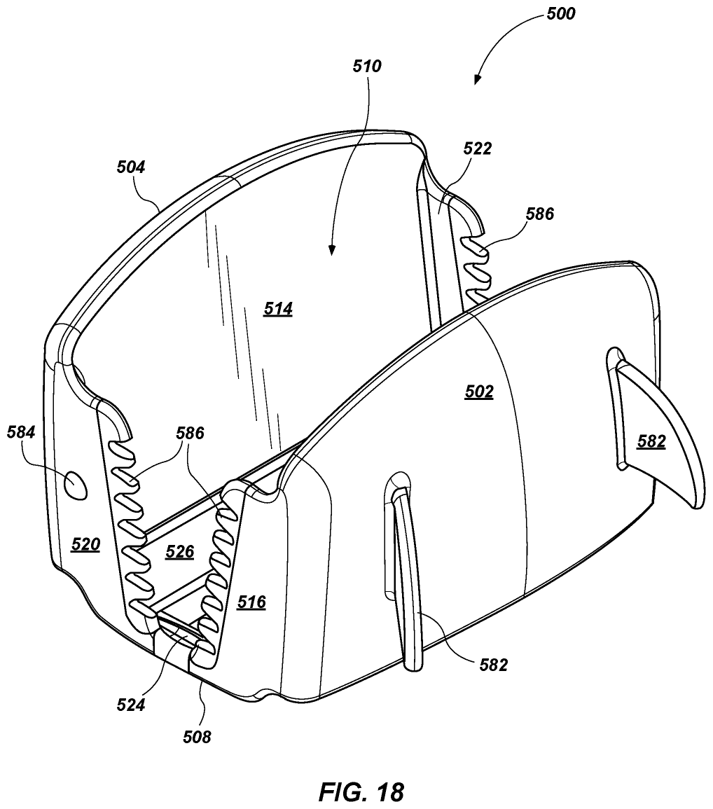

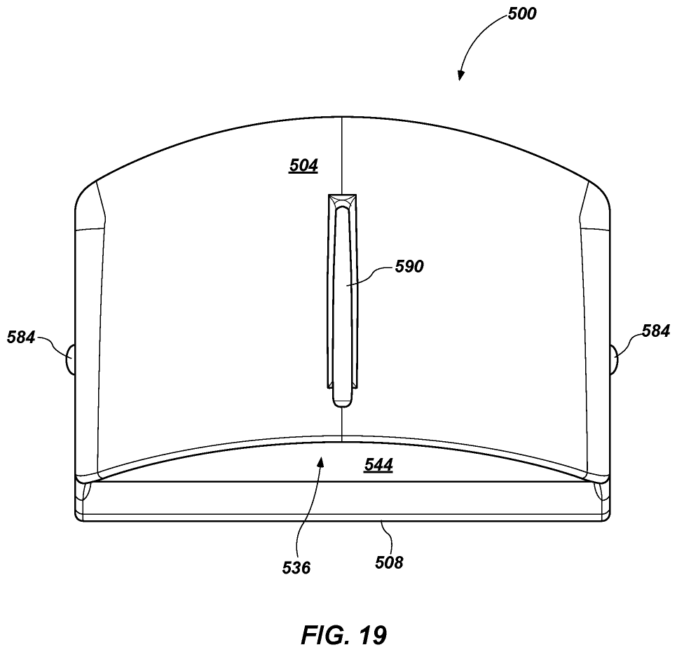

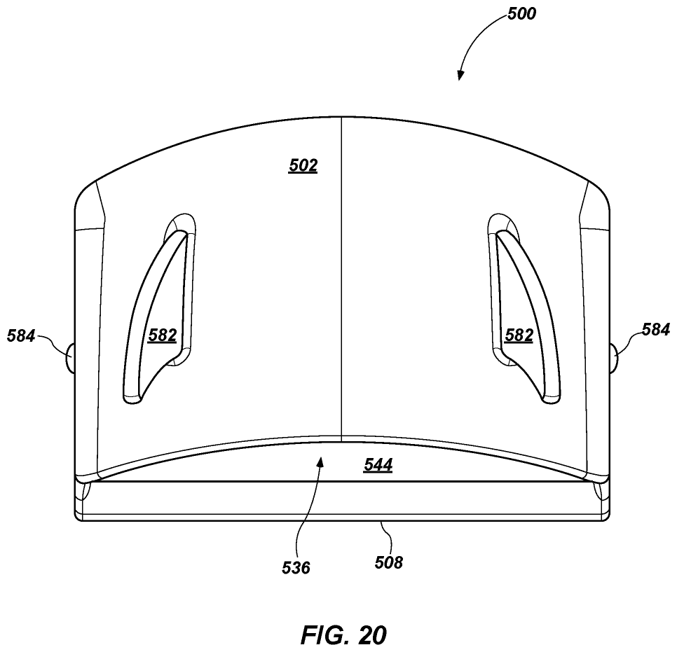

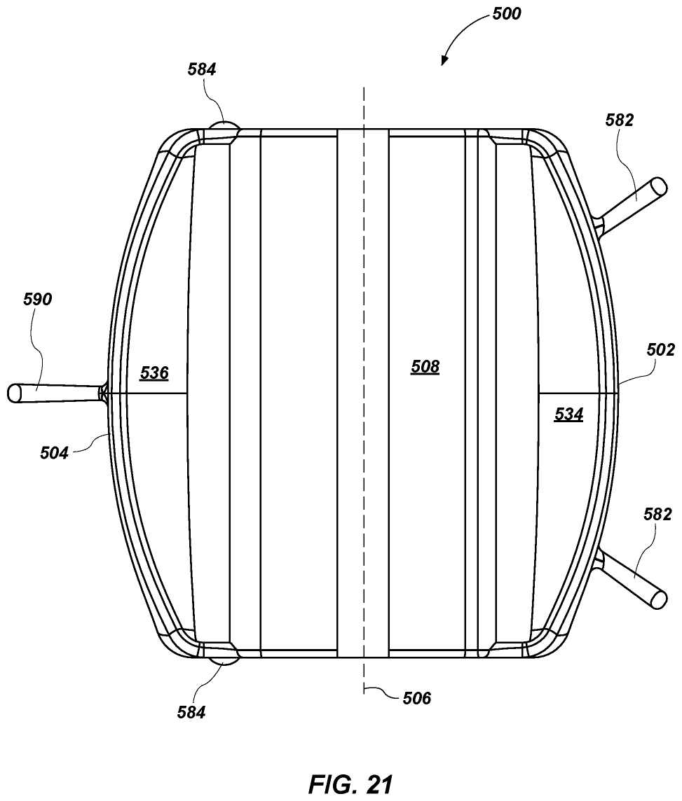

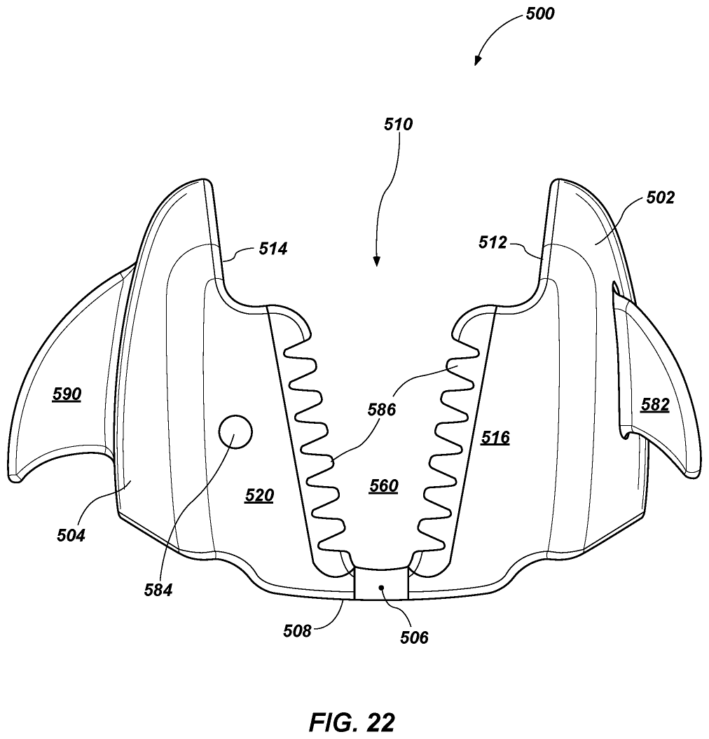

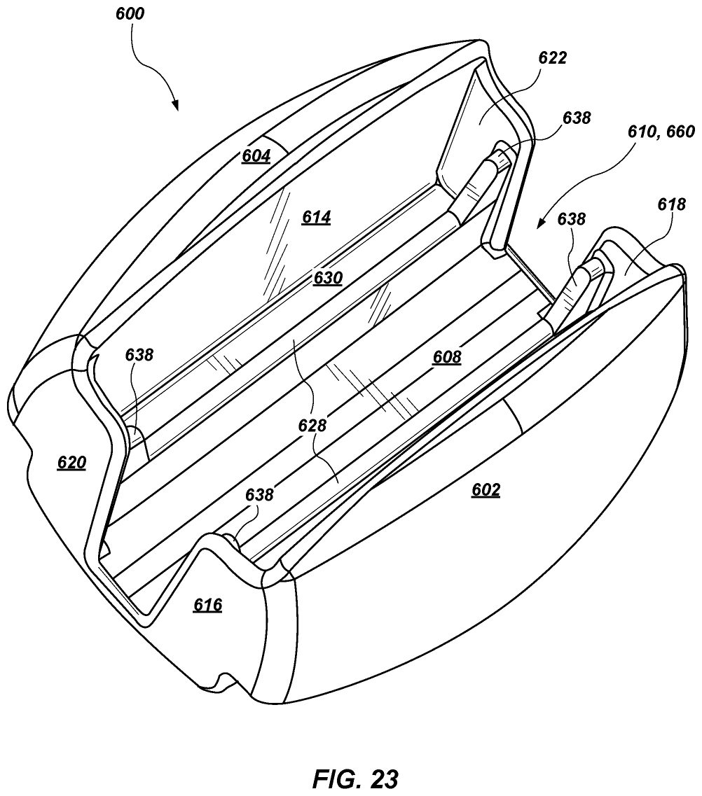

FIGS. 18-22 are perspective, top, bottom, rear and side wireframe views, respectively, of the shark embodiment of the s'more holding device 500 shown in FIG. 17A, according to the present invention. As shown in FIGS. 18-22, the embodiment of a s'more holding device 500 may include right and left clamping members 502 and 504 and a pivot axis 506 passing through the bottom 508 of the holding device 500. The bottom 508 may have a plurality of stiffening ribs 524, see, e.g., FIGS. 17A and 18. The embodiment of a holding device 500 may further include an interior space 510 (FIGS. 18 and 22) and gap 560 (FIG. 22) disposed between right and left clamping members 502 and 504. The embodiment of a holding device 500 may further include fins 516, 518 (see FIG. 17A), 520 and 522 extending from right and left clamping members 502 and 504 and surrounding cracker support walls 526 and 528. Cracker slots 530 and 532 (FIG. 17A) are formed between cracker support walls 526 and 528 and grasping surfaces 512 and 514. The bottom view shown in FIG. 21 best illustrates the finger pockets 534 and 536. FIGS. 19 and 20 illustrates finger pockets 534 and 536 and internal surface 544 formed within each of the right and left clamping members 502 and 504, which are configured to receive the fingers or thumb (neither shown) of a user (also not shown). Aesthetically, the shark embodiment of a s'more holding device 500 may include white coloring on the shark teeth 586 and right clamping member 502 and generally blue coloring elsewhere on the outer surface, except for the two black shark eyes 584. It will be understood that while the particular color selection, i.e., white, blue and black coloring, have been used in this particular bear embodiment of a shark s'more holding device 500, other colors could be employed consistent with the teachings of the present invention.

FIG. 23 is a perspective image of a second embodiment of a s'more catcher 600 in the open position, according to the present invention. Catcher 600 differs from catcher 100 in that it does not include stiffening ribs 124, but does include 4 cracker support wall extensions 638 located in each of the corners of the interior space 610. The 4 cracker support wall extensions 638 provide additional support in holding a cracker in place during assembly and consumption of a s'more. Each of the 4 cracker support wall extensions 638 extend along its associated fin 616, 618, 620 and 622 in a direction upward from the bottom 608. Thus, each of the 4 cracker support wall extensions 638 extends the function and structural support provided by the two cracker support walls 626 and 628

The various embodiments of the s'more holding devices 100, 400, 500 and 600 of the present invention are all generally adapted to allow for the assembly of a s'more and generally function as a grasping element for this assembly and consumption of an assembled s'more. Each of the s'more holding devices 100, 400, 500 and 600 may include a pair of opposed clamping members generally positioned on opposed sides of the devices that are connected through a bottom panel that provides a pivot axis. The opposed clamping members generally define an interior space for each of the s'more holding devices 100, 400, 500 and 600 that has a U-shape or V-shape, with the interior space positioned within a saddle of this U or V-shape and defining a gap. The bottoms of the s'more holding devices 100, 400, 500 and 600 are generally positioned opposite the interior space and are generally adapted to provide resting support to the s'more holding devices 100, 400, 500 and 600. Having described specific embodiments of the s'more holding devices 100, 400, 500 and 600, some additional general embodiments are described below.

An embodiment of a s'more holding device is disclosed. The embodiment of a s'more holding device may include a rectangular bottom having a bottom surface and a upper surface, two opposed long edges, two opposed short edges and a centrally oriented pivot axis passing lengthwise through the bottom and parallel to the two opposed long edges. The embodiment of a s'more holding device may further include two clamping members connected to each of the two opposed long edges of the bottom, each of the two clamping members extending in a direction upward from the upper surface and forming a finger pocket for insertion of a user's thumb or fingers, each pocket forming a thermal membrane, the membrane having an inner digital surface for receiving the user's thumb or fingers and an external grasping surface. According to the embodiment of a s'more holding device, each of the two clamping members may further include a cracker support wall, the cracker support wall extending perpendicularly from and connecting both fins, the cracker support wall extending upward from the upper surface of the rectangular bottom and extending near to, but spaced apart from, the external grasping surface, thereby forming a cracker slot disposed in between the external grasping surface and the cracker support wall, the cracker slot configured to receive and hold a cracker.

According to another embodiment of a s'more holding device, the upper surface of the rectangular bottom may further include a plurality of stiffening ridges formed along the upper surface, each ridge running parallel to one another, perpendicular to the pivot axis and extending between the two cracker support walls. According to yet another embodiment of a s'more holding device, each of the two clamping members may further include two fins, each fin extending from a corner of the rectangular bottom along a short edge toward the pivot axis and upward to support one end of a cracker support wall. According to still another embodiment of a s'more holding device, a gap may be formed between each pair of opposed fins running along the short edges of the rectangular bottom.

According to another embodiment of a s'more holding device, the rectangular bottom may be configured to operate as an open-biased spring loaded hinge that is further configured to allow rotation about the pivot axis, allowing the user to compress the two clamping members towards each other by compressing the fingers and thumb inserted in the finger pockets to grasp a roasted marshmallow between opposed external grasping surfaces. Another embodiment of a s'more holding device may further include cracker support wall extensions integrated into each cracker support wall and fin joint. Each extension may be configured to expand a surface area supporting a cracker inserted into the cracker slot. According to one embodiment of a s'more holding device, the cracker support wall extensions may each have a thickness identical to the cracker support wall. According to various embodiments of a s'more holding device, the device may be formed of an elastomer material, for example and not by way of limitation: nitrile, hydrogenated nitrile, ethylene-propylene, fluorocarbon, chloroprene, silicone, fluorosilicone, polyacrylate, ethylene acrylic, styrene-butadiene, polyurethane and natural rubber.

According to further embodiments, the s'more holding device may further include externally integrated body part features to give the s'more holding device the appearance of an animal. According to one embodiment of a s'more holding device, the externally integrated body part features may include surface coloring, two ears, two eyes and a nose to give the s'more holding device the appearance of a cartoon bear. According to another embodiment of a s'more holding device, the externally integrated body part features may include coloring, four rows of teeth along the fins, two eyes, a dorsal fin and two pectoral fins to give the s'more holding device the appearance of a cartoon shark.

An embodiment of a s'more catcher for assembling and consuming a s'more treat is disclosed. The embodiment of a s'more catcher may include a rectangular bottom having a bottom surface and a upper surface, two opposed long edges, two opposed short edges and a centrally oriented pivot axis passing lengthwise through the bottom and parallel to the two opposed long edges. The embodiment of a s'more catcher may further include two mirror-image clamping members connected to each of the two opposed long edges of the rectangular bottom. According to one embodiment, each clamping member may further include a hollow finger pocket including an inner digital surface, an external grasping surface and an external protective surface, the external grasping and protective surfaces meeting at a rim of the clamping member, the finger pocket configured to receive a user's fingers or thumb, the finger pocket further comprising a thermally insulating membrane disposed between the inner digital surface and the external grasping and protective surfaces. According to this one embodiment, each clamping member may further include two fins extending perpendicularly from opposite ends of the external grasping surface, each fin extending perpendicularly from a corner of the rectangular bottom and along one of the two opposed short edges of the rectangular bottom. According to this one embodiment, each clamping member may further include a cracker support wall extending perpendicularly between the two fins and along the rectangular bottom parallel to the pivot axis.

According to another embodiment of a s'more catcher, the upper surface of the rectangular bottom may further include a plurality of stiffening ridges formed along the upper surface, each ridge running parallel to one another, perpendicular to the pivot axis and extending between the two cracker support walls. According to yet another embodiment of a s'more catcher, each of the two clamping members may further include two fins, each fin extending from a corner of the rectangular bottom along a short edge toward the pivot axis and upward to support one end of a cracker support wall.

According to still another embodiment of a s'more catcher, the rectangular bottom may be configured to operate as an open-biased spring loaded hinge that is further configured to allow rotation about the pivot axis, allowing the user to compress the two clamping members towards each other by compressing the fingers and thumb inserted in the finger pockets to grasp a roasted marshmallow between opposed external grasping surfaces. According to still yet another embodiment, the a s'more catcher may further include cracker support wall extensions integrated into each cracker support wall and fin joint, each extension configured to expand a surface area supporting a cracker inserted into the cracker slot. According to one embodiment of a s'more catcher, the cracker support wall extensions may each have a thickness identical to the cracker support wall. According to various embodiments, the s'more catcher may be formed of a material selected from the group consisting of: nitrile, hydrogenated nitrile, ethylene-propylene, fluorocarbon, chloroprene, silicone, fluorosilicone, polyacrylate, ethylene acrylic, styrene-butadiene, polyurethane and natural rubber.

In understanding the scope of the present invention, the term “configured” as used herein to describe a component, section or part of a device that is constructed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of the device as illustrated in the present invention. Finally, terms of degree such as “substantially”, “about” and “approximately” as used herein mean a reasonable amount of deviation of the modified term such that the end result is not significantly changed.

It will further be understood that the present invention may suitably comprise, consist of, or consist essentially of the component parts, method steps and limitations disclosed herein. However, the invention illustratively disclosed herein suitably may be practiced in the absence of any element which is not specifically disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A s'more holding device, comprising:
a rectangular bottom having a bottom surface and a upper surface, two opposed long edges, two opposed short edges and a centrally oriented pivot axis passing lengthwise through the bottom and parallel to the two opposed long edges;
two clamping members connected to each of the two opposed long edges of the bottom, each of the two clamping members extending in a direction upward from the upper surface and forming a finger pocket for insertion of a user's thumb or fingers, each pocket forming a thermal membrane, the membrane having an inner digital surface for receiving the user's thumb or fingers and an external grasping surface; and
wherein each of the two clamping members further comprise a cracker support wall, the cracker support wall extending perpendicularly from and connecting both fins, the cracker support wall extending upward from the upper surface of the rectangular bottom and extending near to, but spaced apart from, the external grasping surface, thereby forming a cracker slot disposed in between the external grasping surface and the cracker support wall, the cracker slot configured to receive and hold a cracker.

2. The s'more holding device according to claim 1, wherein the upper surface of the rectangular bottom further comprises a plurality of stiffening ridges formed along the upper surface, each ridge running parallel to one another, perpendicular to the pivot axis and extending between the two cracker support walls.

3. The s'more holding device according to claim 1, wherein each of the two clamping members further comprises two fins, each fin extending from a corner of the rectangular bottom along a short edge toward the pivot axis and upward to support one end of a cracker support wall.

4. The s'more holding device according to claim 3, wherein a gap is formed between each pair of opposed fins running along the short edges.

5. The s'more holding device according to claim 1, wherein the rectangular bottom is configured to operate as an open-biased spring loaded hinge that is further configured to allow rotation about the pivot axis, allowing the user to compress the two clamping members towards each other by compressing the fingers and thumb inserted in the finger pockets to grasp a roasted marshmallow between opposed external grasping surfaces.

6. The s'more holding device according to claim 1, further comprising cracker support wall extensions integrated into each cracker support wall and fin joint, each extension configured to expand a surface area supporting a cracker inserted into the cracker slot.

7. The s'more holding device according to claim 6, wherein the cracker support wall extensions each comprise a thickness identical to the cracker support wall.

8. The s'more holding device according to claim 1, wherein the s'more holding device is formed of an elastomer material selected from the group consisting of: nitrile, hydrogenated nitrile, ethylene-propylene, fluorocarbon, chloroprene, silicone, fluorosilicone, polyacrylate, ethylene acrylic, styrene-butadiene and polyurethane and natural rubber.

9. The s'more holding device according to claim 1, further comprising natural rubber.

10. The s'more holding device according to claim 1, further comprising externally integrated body part features to give the s'more holding device the appearance of an animal.

11. The s'more holding device according to claim 10, wherein the externally integrated body part features comprise two ears, two eyes and a nose to give the s'more holding device the appearance of a cartoon bear.

12. The s'more holding device according to claim 10, wherein the externally integrated body part features comprise four rows of teeth along the fins, two eyes, a dorsal fin and two pectoral fins to give the s'more holding device the appearance of a cartoon shark.

13. A method of forming a s'more, comprising:
providing a s'more catcher having two finger pockets configured to receive fingers or thumb and having two cracker slots, a skewer, two crackers, an uncooked marshmallow, a chocolate bar and a source of heat;
inserting the two crackers into the two cracker slots in the s'more catcher, thereby leaving an interior space between the two slotted crackers;
resting the chocolate bar on one of the two crackers;
inserting fingers and thumb of a user into the two finger pockets with the s'more catcher in the open position;
skewering the uncooked marshmallow on a distal end of the skewer;
grasping a proximate end of the skewer;
maneuvering the uncooked marshmallow on the skewer toward and proximate to the source of heat;
roasting the marshmallow on the distal end of the skewer until cooked;
removing the skewered roasted marshmallow from the source of heat;
inserting the skewered roasted marshmallow into the interior space;
clamping the user's fingers and thumb towards each other to grasp the skewered cooked marshmallow; and
pulling the skewer from the roasted marshmallow to form a ready-to-eat s'more.

14. A s'more catcher for assembling and consuming a s'more treat, the s'more catcher comprising:
a rectangular bottom having a bottom surface and a upper surface, two opposed long edges, two opposed short edges and a centrally oriented pivot axis passing lengthwise through the bottom and parallel to the two opposed long edges; and
two mirror-image clamping members connected to each of the two opposed long edges of the rectangular bottom, each clamping member further comprising:
a hollow finger pocket including an inner digital surface, an external grasping surface and an external protective surface, the external grasping and protective surfaces meeting at a rim of the clamping member, the finger pocket configured to receive a user's fingers or thumb, the finger pocket further comprising a thermally insulating membrane disposed between the inner digital surface and the external grasping and protective surfaces;
two fins extending perpendicularly from opposite ends of the external grasping surface, each fin extending perpendicularly from a corner of the rectangular bottom and along one of the two opposed short edges of the rectangular bottom; and
a cracker support wall extending perpendicularly between the two fins and along the rectangular bottom parallel to the pivot axis.

15. The s'more catcher according to claim 14, wherein the upper surface of the rectangular bottom further comprises a plurality of stiffening ridges formed along the upper surface, each ridge running parallel to one another, perpendicular to the pivot axis and extending between the two cracker support walls.

16. The s'more catcher according to claim 14, wherein each of the two clamping members further comprises two fins, each fin extending from a corner of the rectangular bottom along a short edge toward the pivot axis and upward to support one end of a cracker support wall.

17. The s'more catcher according to claim 14, wherein the rectangular bottom is configured to operate as an open-biased spring loaded hinge that is further configured to allow rotation about the pivot axis, allowing the user to compress the two clamping members towards each other by compressing the fingers and thumb inserted in the finger pockets to grasp a roasted marshmallow between opposed external grasping surfaces.

18. The s'more catcher according to claim 14, further comprising cracker support wall extensions integrated into each cracker support wall and fin joint, each extension configured to expand a surface area supporting a cracker inserted into the cracker slot.

19. The s'more catcher according to claim 18, wherein the cracker support wall extensions each comprise a thickness identical to the cracker support wall.

20. The s'more catcher according to claim 14, wherein the s'more catcher is formed of an elastomer material selected from the group consisting of: nitrile, hydrogenated nitrile, ethylene-propylene, fluorocarbon, chloroprene, silicone, fluorosilicone, polyacrylate, ethylene acrylic, styrene-butadiene, polyurethane and natural rubber.
